(19) United States
(12) Patent Application Publication
(10) Pub. No.: US 2007/0009317 A1
(43) Pub. Date: Jan. 11, 2007

(54) Surgical scrub appliance

(76) Inventor: Sweet Hoe Phua, Singapore (SG)

Correspondence Address: OSTROLENK FABER GERB & SOFFEN, 1180 AVENUE OF THE AMERICAS, NEW YORK, NY, 100368403, US

(21) Appl. No.: 10/558,589

(22) PCT Filed: May 24, 2004
(86) PCT No.: PCT/SG04/00149

§ 371 Date: Nov. 29, 2005

(30) Foreign Application Priority Data
May 30, 2003 (SG) 200303510-2

(51) Int. Cl. B43K 8/00

(52) U.S. Cl. 401/196

(57) ABSTRACT

A surgical scrub appliance with a reinforced support is disclosed herein. According to the preferred embodiment, the scrub appliance comprises a support to which a sponge is connected, the support forming two containers for liquid, each container having a sealable opening and a rib member across each container to reinforce each container. Each rib member includes a void and a tapered portion extending from the void which produces a camming action to eject a mould tool after the mould tool forms the void.

This application is an improvement over the surgical scrub appliance described in a PCT patent application PCT/SG00/00061 by the same applicant of the present invention.

### BACKGROUND AND FIELD OF THE INVENTION

This invention relates to a surgical scrub appliance.

An embodiment of the PCT application describes a surgical scrub appliance comprising a support to which a sponge is connected with the support forming two containers for liquid. Each container includes a sealable opening preferably sealed by an elastomeric member having a resealable dispensing opening. The containers are formed as part of the support and the whole support is injection moulded from plastic.

In use, a surgeon grips the surgical scrub appliance, which is typically filled with liquid soap, with one hand, dispenses the soap onto the other hand and “scrubs up” using the sponge. However, the gripping action may cause the shape of the plastic container to deform creating gaps between the rim of the container and the elastomeric member and depending on the orientation of the container during the scrubbing process, this may cause the liquid to leak through the gaps.

It is an object of the present invention to provide a surgical scrub appliance which alleviates the disadvantage of the prior art and/or provide the public with a useful choice.

### SUMMARY OF THE INVENTION

According to a first aspect of the invention, there is provided a surgical scrub appliance comprising a support to which a sponge is connected, the support forming at least one container for liquid, the container having a sealable opening and a rib member extending across the container to reinforce the container.

An advantage of the described embodiment of the invention is that having a rib member across the container reinforces the container (and the support) such that when an elastomeric member, for example, is used to close the opening, this alleviates the problem of gaps being formed between the elastomeric member and the opening when the scrub appliance is being used.

Preferably, the surgical scrub appliance further comprises a further container having a sealable opening and a rib member extending across the container to reinforce the container. In either case, the rib member may comprise a void and the rib member includes a tapered portion which extends from the void. Alternatively, the rib member may comprise an injection moulding tool release portion which is preferably tapered.

Preferably, the tapered portion has a taper angle of at least 20 degrees.

Forming the tapered portion in the rib member provides an alternative method of extracting a moulding tool used to form the void and which forms an independent second aspect of the invention.

According to a second aspect of the invention, there is provided a method of extracting a moulding tool after the moulding tool forms a void in a rib member which has a tapered portion extending from the void, the method comprising the step of ejecting the moulding tool away from the void by a camming action produced between the moulding tool and the tapered portion of the rib member.

Preferably, the moulding tool comprises two cam members. In this case, one cam member is first withdrawn to allow the other cam member to be ejected away from the void by the camming action.

Typically, the rib member is formed using injection moulding.

This invention also relates to a moulding tool for performing the above extraction method, and a rib member having a void and an injection moulding tool release portion.

### BRIEF DESCRIPTION OF THE DRAWINGS

An embodiment of the invention will now be described, by way of example, with reference to the accompanying drawings in which,

FIG. 1 is a front view of a surgical scrub appliance comprising a support which forms two containers and which includes a rib member formed in each container according to a preferred embodiment of the invention;

FIG. 2 is a perspective view of the surgical scrub appliance of FIG. 1 with a portion cut away to reveal more of the rib member;

FIG. 3 illustrates a simple example of forming a void using a mould tool conventionally;

FIG. 4 illustrates a moulding device having cam members to form the void of FIG. 2;

FIG. 5 illustrates the moulding device of FIG. 4 with the cam members in a withdrawn position; and

FIG. 6 shows a cross sectional side view of the moulded scrub appliance of FIG. 2 illustrating taper angles of the tapered portions of the rib member.

### DETAILED DESCRIPTION OF THE PREFERRED EMBODIMENT

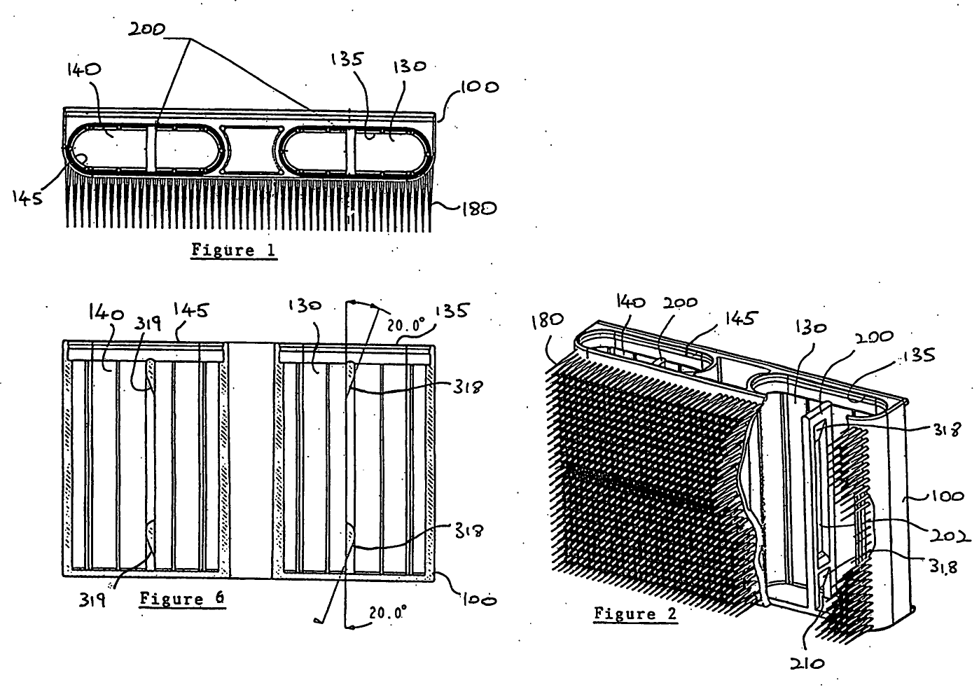

FIG. 1 is a front view of a surgical scrub appliance similar to the second embodiment described in the PCT application PCT/SG00/00061. To summarise the description therein of the second embodiment (using the same reference numerals for the same features), the surgical scrub has a support 100 with a first surface connected to a sponge (not shown here) and a second surface connected to a brush 180. The support 100 forms two containers 130,140, each having a sealable opening 135,145. Preferably, an elastomeric member (not shown) is used to seal each of the openings 135,145.

To reinforce the support 100 and to reduce the effects of the support 100 deforming which creates gaps between the openings 135,145 and the elastomeric member, a rib member 200 is formed inside each container 130,140. Each rib member 200 has two opposing surfaces attached to corresponding inner walls of the container 130,140 and thus reinforces the support 100. Each rib member 200 may be formed by providing a mould tool for defining the rib member 200 during the injection moulding process.

However, the presence of the rib members 200 further compartmentalises (as shown in FIG. 1) each of the containers 130,140 and to facilitate liquid transfer between the two compartments in each container 130,140, a void 202 is preferably formed in the rib member 200 as shown in FIG. 2, which depicts a perspective view of the scrub appliance of FIG. 1 with a section of the brush 180 cut away to show the rib member 200 more clearly.

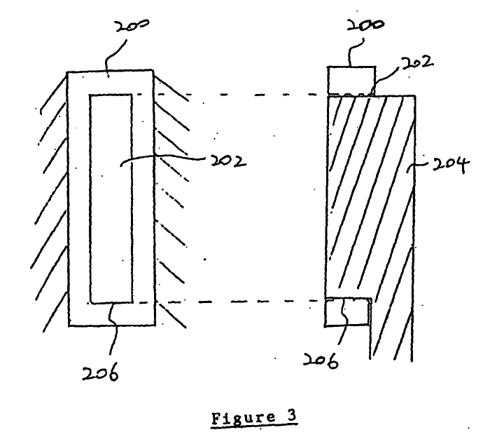

However, conventionally, it is technically difficult to form such a void 202 in the rib member 200 using a mould tool since there is no clearance for withdrawal of the mould tool after forming the void 202. FIG. 3 shows a simple example to illustrate this difficulty. To form the void 202, a mould tool 204 defining the void 202 is inserted into a mould cavity before the moulding process and held in position until completion of the moulding process. When the void 202 is formed, it is difficult to extract the mould tool 204 out of the moulded part since the withdrawal of the mould tool is restricted by an edge 206 of the rib member 202 which extends from the void 202 subsequently formed.

According to the present invention, an alternative method of extracting the mould tool after forming such a void 202 will now be described using injection moulding.

In this embodiment, as noted in FIG. 2, each rib member 200 has two separate voids 202, 210 formed therein the reason which will be apparent after the moulding method is described hereinafter.

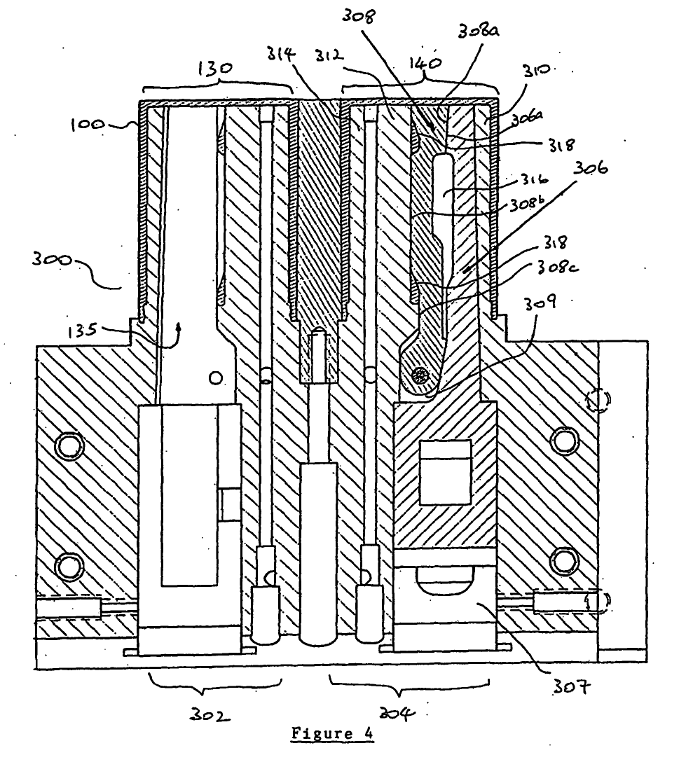

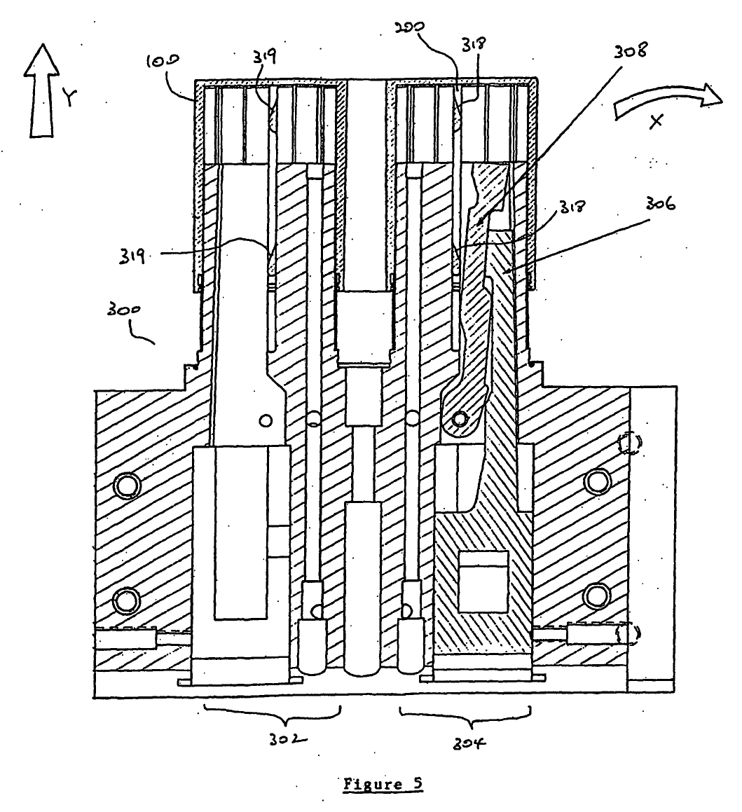

A moulding technique is described in FIGS. 4 and 5 which depict cross-sectional views of part of a moulding device 300. The opening 135 serves as an indication of the orientation of the support 100 with reference to FIGS. 1 and 2. The moulding device 300 comprises two moulding tools 302,304 and corresponding mould halves (not shown) for forming the support 100 of the scrub appliance. The moulding tools 302,304 are used to define two cavities which respectively forms the two containers 130,140 of the support 100. Since the formation of the voids 202, 210 in the two rib members 200 in each container 130,140 are the same with the two moulding tools 302,304 used to define the containers 130,140 being a mirror image of each other, only one side will be described.

The moulding tool 304 comprises two cam members 306,308 for defining the rib member 200 and the voids 202,210 formed in the rib member 200, and mould members 310,312,314 which together with the cam members 306,308 define the internal shape and volume of the container 130.

The first cam member 306 is mounted on a first carriage 307 and is movable slidingly into and out of the container 130 and has a first side which is in sliding fit with the first mould member 310. The first cam member 306 has an engagement surface 306a on a second side to engage a corresponding engagement surface 308a of the second cam member 308 during the moulding process. An arcuate surface extends from each engagement surface 306a,308a to form a space 316 between the two cam members 306,308 when the engagement surfaces 306,308 are aligned with each other as shown in FIG. 4. The second cam member 308 is hinged at one end on a second carriage 309 which when activated withdraws the second cam member 308 out of the scrub appliance. The second cam member 308 together with the second mould member 312 forms the rib member 200 and the cam member 308 includes two surfaces 308b,308c in contact with the second mould member 312 to form the two voids 202,210. The second cam member 308 also includes two tapered grooves which defines a slope portion having a tapered surface 318 in the rib members 200 which extends from the voids 202,210.

FIG. 4 shows the stage when injection moulding has been completed and the moulded support 100 is ready to be removed.

To extract the moulding tool 304 from the support 100, the mould cavity is separated and the first cam member 306 is first withdrawn. When the contact portion 306a of the first cam member 306 is in the space 316, this provides a recess which allows the second cam member 308 to be ejected away in the direction X (FIG. 5) from the voids 202,210 by a camming action between the tapered portions 318 and the corresponding grooves of the second cam member 308. This frees the second cam member 308 so that together with the mould members 310,312,314 and the first cam member 306, these can be withdrawn which releases the support 100 from the mould device 300 in the direction Y as shown in FIG. 5.

FIG. 5 shows a stage after the second cam member 308 has been ejected away from the voids 202,210 and withdrawn together with the first cam member 306 and the mould members 310,312,314. As shown, the mould tool 302 used to form the other container 130 forms two tapered portions 319 of the rib member which are mirror images of the two tapered portions 318.

The formation of the tapered portions 318 (or 319) extending from the voids 202,210 thus creates a camming effect to eject the second cam member 308 away from the voids 202,210 which facilitates the withdrawal of the second cam member 308 reducing damaged to the rib member 200. In this way, one or more voids can be formed in the rib member 200 with greater ease and in a less expensive manner.

The taper or slope angle of the tapered portion 318 varies depending on application and also on the required camming strength to eject the second cam member 308 away from the tapered portion 318. Preferably, for the formation of the two voids 202,210 in the rib member 200 of the scrub appliance, the taper angle is approximately 20 degrees as shown more clearly in FIG. 6. For optimum camming effect, the angle should be at least 20 degrees. However, other acute taper angles may be used which produces different camming strengths.

Preferably, two voids 202,210 are formed in the rib member 200 so that there are correspondingly two tapered portions 318 although functionally for the scrub appliance, only one void is required. The presence of the two tapered portions 318 produces a greater camming effect to eject the second cam member 308 away from the voids 202,210. If one void is formed, then the slope of the tapered surface may be elevated to increase the strength of the camming action. Therefore, the slope of the tapered surface may vary.

It should be apparent that the method of extracting the mould tool 304 after forming voids 202,210 in a rib member 200 is not limited to a scrub appliance. Generally, the method can be used after moulding of any plastic article which requires forming a rib member with an injection moulding tool release portion therein.

In the embodiment of the surgical scrub appliance, with the reinforced support provided by rib member 200, it may not be necessary to form a void 202 in the rib member 200 for the transfer of liquid. To dispense the liquid in the respective compartments in each container, further dispensing openings may be provided on each elastomeric member enclosing the container.

Having now fully described the invention, it should be apparent to one of ordinary skill in the art that many modifications can be made hereto without departing from the scope as claimed.

1. A surgical scrub appliance comprising a support to which a sponge is connected, the support forming at least one container for liquid, the container having a salable opening and a rib member extending across the container to reinforce the container.

2. A surgical scrub appliance according to claim 1, further comprising a further container having a salable opening and a rib member extending across said container to reinforce said container.

3. A surgical scrub appliance according to claim 1, wherein the or each rib member comprises a void.

4. A surgical scrub appliance according to claim 3, wherein the or each rib member includes a tapered portion which extends from the void.

5. A surgical scrub appliance according to claim 4, wherein the tapered portion has a taper angle of at least 20 degrees.

6. A surgical scrub appliance according to claim 1, wherein the or each rib member includes an injection moulding tool release portion.

7. A surgical scrub appliance according to claim 6, wherein the release portion is tapered.

8. A method of extracting a moulding tool after the moulding tool forms a void in a rib member, the rib member having a tapered portion extending from the void, the method comprising the step of: ejecting the moulding tool away from the void by a camming action produced between the moulding tool and the tapered portion of the rib member.

9. A method according to claim 8, wherein the moulding tool comprises two cam members.

10. A method according to claim 9, further comprising the step of withdrawing one cam member to allow the other cam member to be ejected away from the void by the camming action.

11. A method according to claim 8, wherein the rib member is formed using injection moulding.

12. A method according to claim 8 wherein the tapered portion has a taper angle of at least 20 degrees.

13. A mould tool for performing a method according to claim 8.

14. A rib member formed in a plastic receptacle, the rib member including a void, and an injection moulding tool release portion.

15. A rib member according to claim 14, wherein the release portion extends from the void.

16. A rib member according to claim 14 or claim 15, wherein the release portion is tapered.

17. A rib member according to claim 16, wherein the tapered portion has a taper angle of at least 20 degrees.

18. A moulded plastic article having a rib member according to claim 14.
